(19) United States
(12) Patent Application Publication
(10) Pub. No.: US 2007/0133523 A1
(43) Pub. Date: Jun. 14, 2007

(54) Replay caching for selectively paused concurrent VOIP conversations

(75) Inventor: Ohsuk D. Kwon, Sunnyvale, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/297,981

(22) Filed: Dec. 9, 2005

(51) Int. Cl. H04L 12/66

(52) U.S. Cl. 370/356

(57) ABSTRACT

A system, method, and apparatus are directed to enabling a user to manage multiple VOIP sessions concurrently using on-ready replay of buffered VOIP conversations. The user may initiate a plurality of VOIP conversations between different parties. When the user pauses, or otherwise initiates a VOIP conversation with another party, the currently active VOIP conversation(s) are placed in a pause mode that automatically activates recording of a subsequent portion of the conversation provided by the other party. When the user subsequently un-pauses a selected VOIP conversation, the recorded VOIP conversation is automatically played back to the user. By selectively pausing, and un-pausing different VOIP conversations, the user may conveniently manage switching between multiple VOIP conversations. In one embodiment, the pause and un-pausing of VOIP conversations may employ a toggle button, or the like.

### BACKGROUND OF THE INVENTION

The present invention relates generally to network communications, and more particularly, but not exclusively, to a system and method for enabling a user to manage multiple VOIP sessions concurrently using on-ready replay of buffered VOIP conversations.

Internet Protocol (IP) Telephony, also known as Voice over Internet Protocol (VOIP), is a technology that makes it possible to have a voice conversation over an IP network, such as the Internet, instead of a dedicated voice transmission line.

Depending on the service, one way to place a VOIP call is to pick up a phone and dial a number, using an adaptor that connects to an existing high-speed network connection. The call goes through a local telephone company to a VOIP provider. The phone call goes over the Internet to the called party's local telephone company for the completion of the call. Another way is to utilize a microphone headset plugged into a computer. The number is placed using the keyboard and may be routed through an IP network. Still another way is to employ specialized phones, sometimes called IP Phones, or VOIP phones, that may look like a normal phone. Such VOIP phones may connect to the network through an RJ-45 connector, or operate through a wireless connection.

Because VOIP makes it possible to have voice conversations over IP networks, VOIP allows for a cost effective alternative to the traditional public switched telephone networks (PSTNs). Because of its relatively lower costs and ease of use, VOIP phone services have been rapidly increasing in popularity. With such an increase in popularity, there has been an increased desire to improve upon its functionality. For example, currently, a party typically manages a single VOIP conversation at a time. Even during a conference call, a party typically still only manages a single conversation. Therefore, it may be desirable to enable a user to manage multiple concurrent VOIP conversations. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a function block diagram illustrating one embodiment of an environment for practicing the invention;

FIG. 2 shows one embodiment of a client device that may be included in a system implementing the invention; and

FIG. 3 illustrates a logical flow diagram generally showing one embodiment of a process for managing replay of cached selectively paused concurrent VOIP conversations, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. The phrase “in another embodiment” as used herein does not necessarily refer to a different embodiment, although it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” As used herein, “automatic” or “automatically” refers to “without additional user interaction.”

The term “network connection” or simply “connection” refers to a collection of links and/or software elements that enable a computing device to communicate with another computing device over a network. One such network connection may be a TCP connection. TCP connections are virtual connections between two network nodes, and are typically established through a TCP handshake protocol.

The term ‘session’ refers to a series of interactions between two network devices that occur during the span of the connection. Typically, one network device may request a connection with another network device and if that network device replies agreeing to the connection, the network devices may take turns exchanging commands and data, such as may occur during use of a handshaking protocol. The session may be said to begin when the connection is established at both ends and may be said to terminate when the connection is ended. The session enables a conversation, or flow of data to occur between the two network devices. One example of a conversation is a VOIP conversation, wherein a party associated with one of the network devices may employ VOIP to communicate an audio message to another party over the network. Some connections and/or sessions may last only long enough to send a message in one direction. However, other sessions may last longer, usually with one or both of the conversing parties able to terminate it.

Briefly stated, therefore, the present invention is directed towards a system, method, and apparatus that enable a user to manage multiple VOIP sessions concurrently using on-ready replay of buffered VOIP conversations. The user may initiate a plurality of VOIP conversations between different parties. When the user pauses, or otherwise initiates, or switches to a VOIP conversation with another party, the then currently active VOIP conversation is placed in a pause mode that automatically activates recording of a subsequent portion of the VOIP conversation provided by the other party. When the user subsequently un-pauses the paused VOIP conversation, the recorded VOIP conversation is automatically played back. By selectively pausing/recording and un-pausing/playing back of different VOIP conversations, the user may conveniently manage multiple concurrent VOIP conversations.

In one embodiment, the pausing and un-pausing of VOIP conversations may employ a toggle button, or the like. In one embodiment, placing a VOIP conversation into a pause mode may be substantially similar to placing a telephone party on hold, in that the ‘paused party’ may still provide audio messages over the network. However, the paused party may, in one embodiment, be provided a message, or other signal indicating that they are in the pause mode.

Illustrative Operating Environment

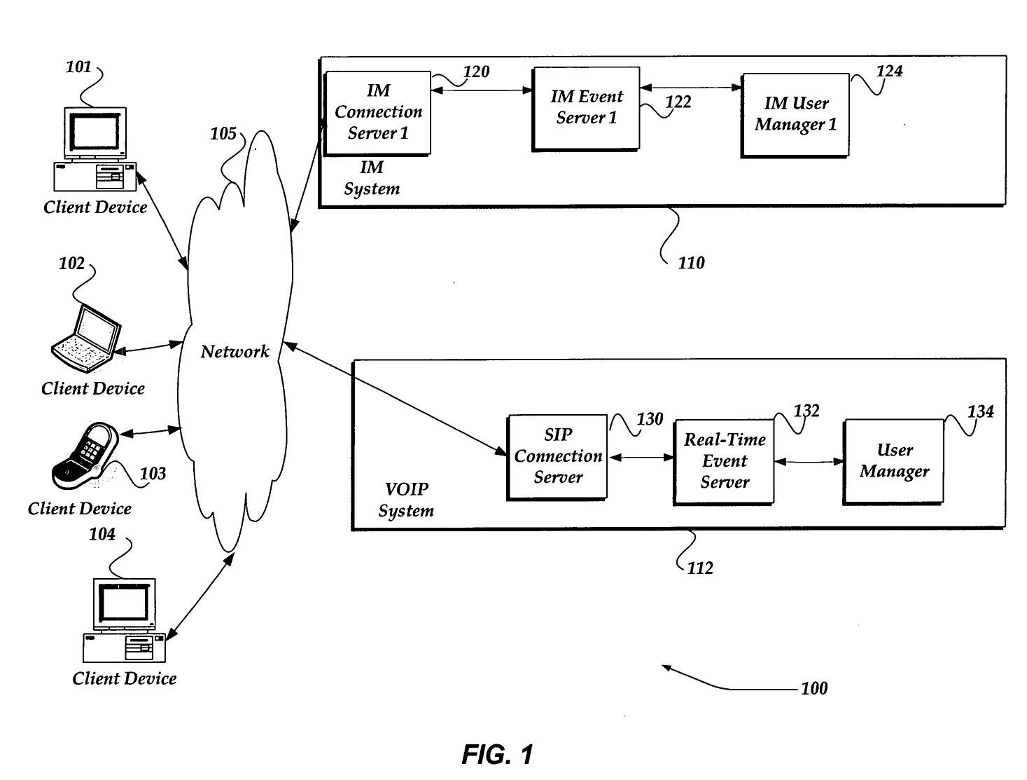

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 101-104, network 105, IM system 110, and VOIP system 112. IM system 110 may include IM connection server 120, IM event server 122, and IM user manager 124. VOIP system 112 may include Session Initiation Protocol (SIP) connection server 130, Real-Time event server 132, and user manager 134.

Client devices 101-104 are in communication with IM connection server 120, SIP connection server 130, and each other, through network 105. IM event server 122 is in communication with IM connection server 120 and IM user manager 124. Real-time event server 132 is in communication with SIP connection server 130 and user manager 134.

One embodiment of client devices 101-104 is described in more detail below in conjunction with FIG. 1. Briefly, however, client devices 101-104 may include virtually any computing device capable of connecting to another computing device and receiving information. Such devices may include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client devices 101-104 may also include other computing devices, such as personal computers, desktop computers, multiprocessor systems, microprocessor-based or programmable consumer electronics, network PCs, and the like. As such, client devices 101-104 may range widely in terms of capabilities and features. For example, a client device configured as a VOIP phone may have a numeric keypad and a few lines of monochrome LCD display. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 101-104 also may include at least one client application that is configured to receive content from another computing device. The client application may include a capability to provide and receive textual content, graphical content, audio content, alerts, messages, and the like. Moreover, client devices 101-104 may be further configured to communicate a message, such as through a Short Message Service (SMS), Multimedia Message Service (MMS), instant messaging (IM), internet relay chat (IRC), mIRC, Jabber, and the like, between another computing device, and the like.

Client devices 101-104 may also be enabled to communicate using Voice over Internet Protocol (VOIP). For example, client devices 101- 104 may employ Real-time Transport Protocol (RTP) for communicating media data such as audio and video to another device. However, the invention is not so limited, and another communication protocol may be employed, including IAX, and the like. Client devices 101-104 may also employ the Session Initiation Protocol (SIP) protocol for enabling setting up a session and enabling such actions as dialing a number, enabling a ring, a ring-back tone, busy signal, and the like. However, other signaling protocols may also be employed, including H.323, Skinny Client Control Protocol (SCCP), IAX, MiNET, and the like. Typically, however, client devices 101-104 may employ SIP over either User Datagram Protocol (UDP) or Transmission Control Protocol (TCP) and RTP over UDP. In one embodiment, client devices 101-104 may employ a VOIP client application to perform VOIP communications. In one embodiment, the VOIP client application may be integrated within another application, such as an IM client application, or the like.

Moreover, client devices 101-104 may include another client application that is configured to enable a user to manage multiple VOIP sessions concurrently using on-ready replay of buffered VOIP conversations. For example, as different VOIP sessions are established between one or move client devices enabling different portions of VOIP conversations to be communicated over network 105, the VOIP conversations may be paused, or otherwise placed on hold. As a VOIP conversation is paused, the client application enables a subsequent portion of the paused VOIP conversation to be automatically recorded. This allows a party associated with the paused VOIP conversation to provide continued communications over the network. When a paused VOIP conversation is un-paused, a different un-paused VOIP may be automatically paused, and automatic recording of a subsequent portion of the now paused VOIP conversation activated. Moreover, the client application may, in one embodiment, provide automatic playback of the recorded portion for the now un-paused VOIP conversation. Thus, the client application enables the user to manage multiple VOIP conversations by selectively pausing or un-pausing different VOIP conversations, which in turn enables automatic recording of the paused VOIP conversations, and may enable automatic playback of the un-paused recorded VOIP conversation.

The client application may also enable a message, signal, or the like to be sent to a party associated with a VOIP conversation indicating whether the party is in a pause mode, or an “active” (un-paused) mode. Moreover, the client application may also enable a message, signal, or the like, to be available at the client device indicating which VOIP conversations are paused, un-paused, or the like.

In one embodiment, when the user terminates a VOIP session without automatically playing back the associated portion of the recorded VOIP conversation, the client application may redirect the recorded VOIP conversation to a voicemail, or the like. In this manner, the user may readily locate and replay the recorded VOIP conversation at another time. In another embodiment, recorded portions of VOIP conversation of virtually any of the terminated VOIP sessions may also be retained for later playback, whether or not it has be played back.

It should be noted that one or more of client devices 101-104 may selectively pause or un-pause different VOIP conversations at about the same time. For example, client devices 101-104 may each participate in VOIP conversations with each other. Client device 101 may place client devices 102-103 into a pause mode, keeping the VOIP conversation with client device 104 active. Client device 104 may select to activate a VOIP conversation with client device 102, while placing client devices 101 and 103 into pause mode. In this arrangement, client device 101 may provide at a portion of the VOIP conversation to be recorded by client device 104, while client devices 102 and 104 may be ‘actively’ communicating.

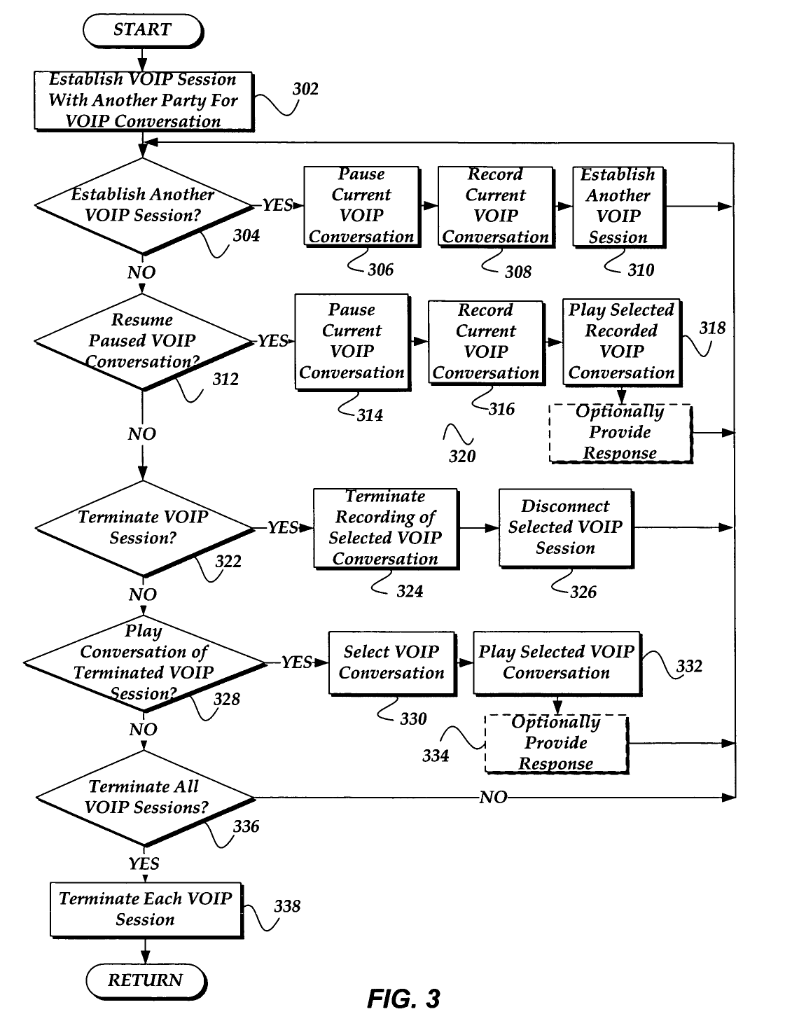

In one embodiment, the client application may be integrated within another application, such as a VOIP client application, an IM client application, or the like. Moreover, in one embodiment, the client application in conjunction with other applications may employ a process such as described below in conjunction with FIG. 3 to perform at least some of its actions.

Client devices 101-104 may also be configured to provide an address during a communication. The address may employ any of a variety of mechanisms, including a device model number, a carrier address, a mobile identification number (MIN), or the like. The MIN may be a telephone number, a Mobile Subscriber Integrated Services Digital Network (MSISDN), an electronic serial number (ESN), or other device address. The address may also be an IP address associated with one of the client devices 101-104. In one embodiment, client devices 101-104 may also provide information associated with an account for a network service, or the like.

Network 105 is configured to couple one computing device with another computing device. Network 105 may be enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link.

Network 105 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Network 105 may also include an autonomous system of terminals, gateways, routers, and the like connected by wireless radio links, and the like. These connectors may be configured to move freely and randomly and organize themselves arbitrarily, such that the topology of network 105 may change rapidly.

Network 105 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, and future access networks may enable wide area coverage for mobile devices with various degrees of mobility. For example, network 105 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. In essence, network 105 may include virtually any wired and/or wireless communication mechanisms by which information may travel between one computing device and another computing device, network, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

IM system 110 is configured to manage IM sessions between client devices employing an IM client. IM system 110 may employ IM connection server 120, IM event server 122, and IM user manager 124 to manage one or more IM sessions. In one embodiment, IM connection server 120, IM event server 122, and IM user manager 124 may represent separate server processes operating with a single computing device. In another embodiment, IM connection server 120, IM event server 122, and IM user manager 124 may represent distinct processes operating across multiple computing devices. As such, IM system 110 may be implemented on a variety of computing devices including personal computers, desktop computers, multiprocessor systems, microprocessor-based devices, network PCs, servers, network appliances, and the like.

IM connection server 120 is configured to receive a request to establish an IM session from an IM client, such as might be included within client devices 101-104, or the like. IM connection server 120 may also receive from the IM client authentication information that may be employed to authenticate an end-user of the IM client. If the end-user is authenticated, IM connection server 120 may enable the IM client to log into the IM session. IM connections servers 120 may also be configured to provide information about the established session to IM event server 122. IM connection server 120 may also forward various request information from the EM client to IM event server 122. Such request information may include, for example, a request to locate and communicate with another IM end-user.

IM event server 122 is configured to receive the end-user's log in and other request information from IM connections servers 120. IM event server 122 may request IM user manager 124 to store information about the IM client and end-user. IM user manger 124 may employ a table, spreadsheet, file, database, and the like, to register the IM client, and on which IM connection server, within IM connection server 120, the IM client is logged into. Thus, IM user manager 124 may store information about various IM conversations that may include such information as identifiers for end-users associated with an IM conversation, time information, account identifiers for the end-users, IM connection servers associated with an IM conversation, and so forth. As such, IM event server 122 may also employ IM user manager 124 to determine which IM connection server, within IM connection server 122, another end-user is logged into, and provide such information to IM connection server 120, so that an IM session may be established between two or more IM end-users.

VOIP system 112 is configured to manage VOIP sessions between client devices using any of a variety of VOIP protocols. VOIP system 112 is further configured to enable a variety of client devices and client applications to access voice mail messages.

As shown, VOIP system 112 may be implemented in a single computing device, with each of the illustrated components operating as one or more processes with the single computing device. VOIP system 112 may also be implemented across multiple computing devices, with one or more of the illustrated components distributed across the multiple computing devices. As such VOIP system 112 may be implemented on a variety of computing devices including personal computers, desktop computers, multiprocessor systems, microprocessor-based devices, network PCs, servers, network appliances, and the like.

SIP connection server 130 is configured to receive a request to establish a SIP connection from client devices 101-104, or the like. The requesting device may provide identification information to SIP connection server 130 that may be used, at least in part, to authenticate the request to establish the SIP connection. If the requesting device is authenticated, SIP connection server 130 may enable the requesting device to log into a connection. SIP connection server 130 may also provide information about the requesting device to real-time event server 132. Real-time event server 132 may be configured to receive the information and provide it to user manager 134 for storage.

User manager 134 may store the information in a database, spreadsheet, table, file, and the like. Such information may include, for example, an identifier associated with the requesting device, an end-user associated with the requesting device, an address associated with SIP connection server 130, and the like. User manager 134 may receive and manage such information for a plurality of requesting devices. User manager 134 may also provide information to real-time event server 132 about at least one other requesting device, such that SIP connection server 130 may enable a VOIP communication between one or more end-user devices, such as client devices 101-104, and the like.

Illustrative Client Device

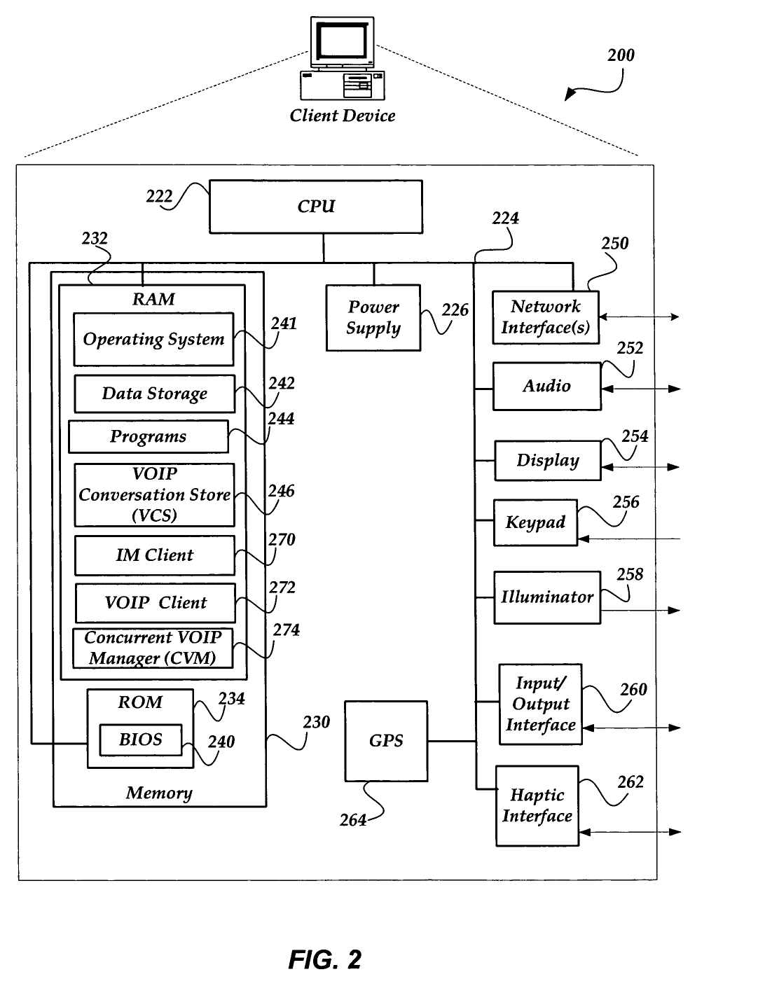

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention.

As shown in the figure, client device 200 includes central processing unit (CPU) 222 in communication with mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), UDP, TCP/Internet protocol (TCP/IP), SMS, general packet radio service (GPRS), WAP, ultra wide band (UWB), IEEE 802.16 Worldwide Interoperability for Microwave Access (WiMax), SIP/RTP, and the like. Network interface unit 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian ® operating system. The operating system may include, or interface with a Java virtual machine module that enables control of hardware components and/or operating system operations via Java application programs.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

Programs 244 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, codec programs, and so forth. In addition, mass memory 230 stores VOIP Conversation Store (VCS) 246, IM client 270, VOIP client 272, and Concurrent VOIP Manager (CVM) 274. Although illustrated as distinct application programs, IM client 270, VOIP client 272, and/or CVM 274 may also be integrated with each other, sub-components of at least one other application, or any combination of distinct and/or integrated components. Thus, in one embodiment, CVM 274 may be integrated within IM client 270, and/or VOIP client 272, without departing from the scope or spirit of the invention. In addition, although VCS 246 is illustrated as residing in RAM 232, the invention is not so limited. For example, VCS 246 may also reside within a local hard drive, removable storage device, or the like. Moreover, in one embodiment, VCS 246 may also be stored remotely, such as at a server device, or the like, such as within IM system 110, VOIP system 112 of FIG. 1, or another server device (not illustrated).

VCS 246 may include an audio data store that is configured to maintain and store VOIP conversation data associated with a plurality of VOIP conversations. VCS 246 may employ any of a variety of protocols and/or mechanisms for recording and storing the VOIP conversation data, including, but not limited to Moving Pictures Experts Group Audio (MPEG) such as MP2, MP3, MPEG-4 Advanced Audio Coding (AAC), or the like; Dolby Digital, EPAC; Window's Media Audio (WMA); QuickTime; Audio Interchange File Format (AIFF); Audio file (AU); or the like.

In still another embodiment, VCS 246 may be directed to optimizing the use of resources by employing an algorithm that might not record when a volume is below a minimum value, or based on some other measure of silence, including such as pitch, a quality of an audio signal, or the like. In one embodiment, VCS 246 may also employ any of a variety of audio compression techniques to further optimize the use of resources.

VSC 246 may enable VOIP conversations to be recorded based on a variety of schemes. For example, in one embodiment, VSC 246 may maintain prior portions of a VOIP conversation when additional portions of the same VOIP conversation are recorded. Thus, in one embodiment, an entire VOIP conversation may be recorded. In another embodiment, VSC 246 may delete portions of VOIP conversations that have been played once, a pre-determined number of times, or the like. However, the invention is not so limited. For example, in one embodiment VCS 246 may continue to record portions of the VOIP conversation even during a rewind and replay of another portion of the VOIP conversation.

IM client 270 may be configured to initiate and manage an instant messaging session. IM client 270 may include, but not be limited to AOL Instant Messenger, Yahoo! Messenger, NET Messenger Server, ICQ, or the like. In one embodiment, IM client 270 may be configured to employ a VOIP client, such as VOIP client 272 to integrate IM/VOIP features. Thus, in one embodiment, IM client 270 may employ SIP to establish media sessions with another computing device employing an IM/VOIP capable client, and RTP to communicate the media traffic. However IM client 270 is not so limited. For example, IM client 270 may also employ any of the following SIMPLE (SIP for Instant Messaging and Presence Leverage), APEX (Application Exchange), Prim (Presence and Instant Messaging Protocol), the open XML-based XMPP (Extensible Messaging and Presence Protocol), more commonly known as Jabber and OMA (Open Mobile Alliance)'s IMPS (Instant Messaging and Presence Service) created specifically for mobile devices, and the like.

VOIP client 272 is configured to enable client device 200 to initiate, manage, and terminate a VOIP session with another client device. VOIP client 272 may employ the SIP protocol for managing signaling, and RTP for transmitting the VOIP traffic (“media”). However, the invention is not so constrained, and any of a variety of other VOIP protocols may be employed including IAX which carries both signaling and voice data, H.323, SCCP, Megaco, MGCP, MiNET, Skinny Client Control Protocol (SCCP),and the like. VOIP client 272 may be further configured to employ virtually any media codec to compress the media stream for communicating it over the network, including G.711, G.729, G.729a, iSAC, Speex, and the like. In one embodiment, SIP may be employed to enable a Session Description Protocol (SDP).

VOIP client 272 may be further configured to manage a flow of VOIP packets to and/or from another computing device. In one embodiment, at least a portion of the flow of VOIP packets is associated with a VOIP conversation between parties to the VOIP session. In one embodiment, VOIP client 272 may provide the packets using RTP with RTCP. VOIP client 272 may also employ an RTCP report from a destination device to determine various qualities of communications, including flow control, congestion control, quality of service, and the like. VOIP client 272 may, for example, determine, based at least in part, on the RTCP report that it may want to modify its transmission of the RTP packets. Thus, in one embodiment, VOIP client 272 may elect to employ a lower speed codec, or the like. Such actions by VOIP client 272 are directed towards reducing a number of packets transmitted, and/or otherwise slowing down the flow of packets. This may provide the destination device a sufficient opportunity to catch-up. The invention is not limited to modifying the codecs, however, and virtually any other mechanism may be employed to modify the transmission of packets, without departing from the scope or spirit of the invention.

Although not shown, client device 200 may also be configured to receive a message from another computing device, employing another mechanism, including, but not limited to email, Short Message Service (SMS), Multimedia Message Service (MMS), internet relay chat (IRC), mIRC, and the like.

CVM 274 is configured to enable a user to manage multiple VOIP sessions concurrently using on-ready replay of buffered VOIP conversations. CVM 274 may interact with VOIP client 272, IM client 270, and/or VCS 246 to perform its actions. Moreover, CVM 274 may employ a process such as described below in conjunction with FIG. 3 to perform at least some of its actions.

CVM 274 may determine when a VOIP session is established such that a portion of an associated VOIP conversation may be communicated between parties over a network. CVM 274 may further determine when another VOIP session is established that enables another VOIP conversation to be communicated. In one embodiment, VOIP client 272 may communicate with CVM 274 to indicate a status of a VOIP session, including whether it is active, established, terminated, or the like. When the other VOIP is detected as ‘active’, CVM 274 may automatically pause or otherwise direct the first VOIP conversation to be placed into a hold mode. Such pause or hold mode is configured to enable the ‘paused’ party to the VOIP conversation to continue to communicate a subsequent portion of the VOIP conversation over the network. However, in one embodiment, the user of client device 200 may not hear the paused transmitted VOIP conversation. Instead, CVM 274 may enable automatic recording of the subsequent portion of the paused VOIP conversation using VCS 246, or the like. In one embodiment, when the VOIP conversation is paused, CVM 274 may further enable a message, signal, or the like, to be sent to the paused party's device indicating that the VOIP conversation is paused.

CVM 274 may further detect when a paused VOIP conversation is un-paused. In one embodiment, VOIP conversations may be paused or un-paused by the user via a toggle button, switch, of the like. In another embodiment, selecting of an interface associated with a VOIP conversation may automatically un-pause, or otherwise activate the selected VOIP conversation. Moreover, un-pausing of one VOIP conversation may automatically place any other currently un-paused VOIP conversation into a pause mode. In one embodiment, when the VOIP conversation is un-paused, CVM 274 may further enable a message, signal, or the like, to be sent to the un-paused party's device indicating that the VOIP conversation is un-paused or ‘active’. In one embodiment, an un-paused or active VOIP conversation may indicate that the user of client device 200 is available to provide a portion of the VOIP conversation to the un-paused party.

When CVM 274 detects that a paused VOIP conversation is un-paused, CVM 274 may further enable a recorded portion of the un-paused VOIP conversation to be automatically played for the user. In one embodiment, the playing of the VOIP conversation begins at a position in the VOIP conversation that has not been previously played. However, the invention is not so limited. For example, the user may, in another embodiment, select also or instead to play a portion of the VOIP conversation that has been played earlier.

Moreover, as a VOIP conversation is paused, CVM 274 enables automatic recording of another portion of the VOIP conversation, while the VOIP conversation is paused. This enables the paused party to continue the VOIP conversation independent of whether the VOIP conversation is ‘active.’

CVM 274 may further detect when a VOIP session associated with a VOIP conversation is terminated. In one embodiment, CVM 274 may enable the user of client device 200 to playback a portion of the VOIP conversation associated with the terminated VOIP session. In one embodiment, the recorded portion of the terminated VOIP conversation may be available through the user's voicemail. However, the invention is not so limited. For example, the recorded portion of the terminated VOIP conversation may also be available through VOIP client 272, CVM 274, another audio player application, or the like.

Moreover, CVM 274, in conjunction with one or more other applications, may enable the user to continue the terminated VOIP conversation by, for example, being automatically redirected to a voicemail, or the like, that is associated with the party of the terminated VOIP conversation. In this manner, the user may provide a response, or otherwise continue the terminated VOIP conversation.

Generalized Operation

The operation of certain aspects of the invention will now be described with respect to FIG. 3. FIG. 3 illustrates a logical flow diagram generally showing one embodiment of a process for managing replay of cached selectively paused concurrent VOIP conversations. Process 300 of FIG. 3 may be implemented within one or more client devices 101-104 of FIG. 1.

As shown in the figure, process 300 begins, after a start block, when a VOIP session is established that enables a VOIP conversation between parties over a network. For sake of illustration, referring to client devices 101-104 of FIG. 1, assume that process 300 is being performed by client device 101. In this illustrative example, client device 101 establishes a VOIP session with client device 102 to enable the parties to transmit at least a portion of a VOIP conversation.

Processing then flows to decision block 304 where a determination is made whether another VOIP session is to be established that enables another VOIP conversation to be communicated with a different client. Continuing the example, assume that client device 101 establishes a VOIP session with client device 103. In one embodiment, the user may select to open an interface that initiates a VOIP call to another device, thereby establishing the other VOIP session. However, the invention is not so limited, and another mechanism may be employed to establish the other VOIP session, without departing from the scope or spirit of the invention. In any event, if another VOIP session is to be established, processing branches to block 306; otherwise, processing continues to decision block 312.

At block 306, a currently active VOIP conversation is placed into pause mode. As described above, pause mode may operate substantially similar to placing a party to a typical telephone conversation on hold. That is, the other party may still speak, providing a subsequent portion of the conversation. However, the user that placed the party in pause may not actually hear the subsequent portion of the conversation. Process 300 continues to block 308, where automatic recording of the subsequent portion of the VOIP conversation is initiated. Thus, although the user may not currently hear the ‘paused’ conversation, it is recorded for later playback. Processing then flows to block 310 where the other VOIP session is established such that another VOIP conversation may be transmitted over the network. Processing then loops back to decision block 304, where it may be possible to establish a plurality of VOIP sessions, each with a corresponding VOIP conversation enabled. Moreover, as each VOIP conversation is enabled, the currently ‘active’ VOIP conversation is paused, and recording of a subsequent portion of the paused VOIP conversation is automatically recorded.

Continuing the above example, client device 101 may, for example, enable a VOIP conversation with client device 103, which thereby automatically places client device 102 into a pause mode and further automatically enables a subsequent portion of a VOIP conversation sent by client device 102 to be automatically recorded. Subsequently, client device 101 may further enable a VOIP conversation with client device 104, which in turn places client device 103 into a pause mode, automatically records a subsequent VOIP conversation from client device 103, and establishes the VOIP session with client device 104.

At decision block 312, a determination is made whether a paused VOIP conversation is selected to be resumed. Selection to un-pause a VOIP conversation may be performed using any of a variety of mechanisms, including, but not limited to, employing a toggle button that pauses/un-pauses a VOIP conversation, selecting a VOIP session interface associated with the VOIP conversation to be un-paused (resumed), selecting an icon associated with a party to the paused VOIP conversation, or the like. In the example, the user of client device 101 may determine that the party of client device 102 has recorded a subsequent portion of the associated VOIP conversation. Therefore, the user may select to un-pause the VOIP conversation associated with client device 102. If it is determined that a paused VOIP conversation is to be resumed, processing flows to block 314; otherwise, processing continues to decision block 322.

At block 314, a currently active VOIP conversation is paused. Processing continues to block 316, where a subsequent portion of the now paused VOIP conversation is automatically recorded. Processing continues to block 318, next, where the recorded VOIP conversation associated with the selected un-paused VOIP conversation is automatically played back. Process 300 flows next to block 320, where the user may then provide a response. Although block 320 is illustrated here, it is noted that it is optional. That is, the user may select to listen to the recorded VOIP conversation but, instead terminate the VOIP conversation, or otherwise, select not to provide a response. In any event, processing then loops back to decision block 304.

To continue the example, the user of client device 101 may select to un-pause client device 102. In which instance, client device 104 may be paused, and a subsequent portion of the associated VOIP conversation may automatically be recorded. Moreover, client device 101 may automatically play back the recorded VOIP conversation from client device 102.

At decision block 322, a determination is made whether to terminate a VOIP session. If it is determined that a VORP session is to be terminated, processing flows to block 324; otherwise, processing continues to decision block 328.

At block 324, any recording of a VOIP conversation associated with the VOIP session to be terminated is also closed. In one embodiment, the closed recorded portion of the VOIP conversation may still be available for playback using a variety of mechanisms. In another embodiment, termination of a VOIP session may result in no available portion of the recorded VOIP conversation. For example, where the user plays the recorded VOIP conversation prior to selecting to terminate the VOIP session, no additional portions of the VOIP conversation may have been recorded. Next, processing flows to block 326, where the selected VOIP session is terminated. Process 300 then loops back to decision block 304.

At decision block 328, a determination is made whether to playback a portion of a selected VOIP conversation associated with a terminated VOIP session. If a VOIP conversation associated with a terminated VOIP session is to be played back, processing flows to block 330; otherwise, processing flows to decision block 336.

At block 330, the VOIP conversation is selected, and at block 332, the selected VOIP conversation is played back. Selection and play back may employ a variety of mechanisms, including, but not limited, to accessing the selected VOIP conversation through voicemail, through a VOIP client, or other audio player at a same or different computing device. Processing then proceeds to block 334, where optionally a response to the selected VOIP conversation may be provided. In one embodiment, the response may be provided using voicemail, or the like. Processing then loops back to block 302.

At decision block 336, a determination is made whether all VOIP sessions are to be terminated. If not, then processing loops back to decision block 302; otherwise, processing flows to block 338, where each of the established VOIP sessions are terminated. In one embodiment, any outstanding recordings of portions of VOIP conversations may also be saved for future playback. Processing then returns to a calling process to perform other actions.

It is noted, that the order or sequence of the above blocks within flowchart illustration may be modified, without departing from the scope or spirit of the invention. For example, blocks 306, 308, and/or 310 may be performed in a different sequence, concurrently, or the like. Similarly, blocks 314, 316, and/or 318 may also be performed concurrently, or in a different sequence.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of managing multiple VOIP conversations over a network, comprising:
establishing a first VOIP session that enables a portion of a first VOIP conversation to be communicated over the network;
establishing a second VOIP session that enables a portion of a second VOIP conversation to be communicated over the network, wherein establishing the second VOIP session further comprises pausing the first VOIP conversation and automatically recording a subsequent portion of the first VOIP conversation while the first VOIP conversation is paused; and
if the first VOIP conversation is resumed, automatically pausing the second VOIP conversation and automatically recording a subsequent portion of the second VOIP conversation, and further automatically playing the recorded portion of the first VOIP conversation.

2. The method of claim 1, wherein pausing the first VOIP conversation or the second VOIP conversation further comprises sending a message indicating that the VOIP conversation is paused.

3. The method of claim 1, wherein automatically recording further comprises enabling a party associated with the paused VOIP conversation to provide audio data over the network.

4. The method of claim 1, further comprising:
establishing a third VOIP session that enables a portion of a third VOIP conversation to be communicated over the network, wherein establishing the third VOIP session further comprises pausing the first or the second VOIP conversation which ever is un-paused, and automatically recording a subsequent portion of the paused VOIP conversations.

5. The method of claim 1, further comprising:
terminating a VOIP session associated with at least one of the first or the second VOIP conversation, wherein at least a portion of the first or second VOIP conversation being recorded; and
enabling the associated recorded portion of the VOIP conversation to be accessible for playback over voicemail.

6. A modulated data signal configured to include program instructions for performing the method of claim 1.

7. A system for managing a plurality of VOIP conversations over a network, comprising:
a processing component for executing data that enables actions, including:
enabling a portion of a first VOIP conversation to be communicated over the network;
enabling a portion of a second VOIP conversation to be communicated over the network, wherein enabling the portion of the second VOIP conversation to be communicated includes pausing the first VOIP conversation, and automatically recording a subsequent portion of the first VOIP conversation; and
selecting to resume the first VOIP conversation further comprises pausing the second VOIP conversation and enabling a subsequent portion of the second VOIP conversation to be automatically recorded and the recorded portion of the first VOIP conversation being automatically played.

8. The system of claim 7, the actions further comprising:
terminating a VOIP session associated with at least one of the first or the second VOIP conversation;
enabling the VOIP conversation associated with the terminated VOIP session to be resumed by directing a response to voicemail.

9. The system of claim 7, wherein the portions of recorded VOIP conversations are stored on at least one of the system or a remote server.

10. The system of claim 7, the actions further comprising:
enabling a portion of a third VOIP conversation to be communicated over the network, wherein enabling the third VOIP conversation to be communicated further comprises pausing the first VOIP conversation and enabling another subsequent portion of the first VOIP conversation to be automatically recorded and the recorded portion of the second VOIP conversation being automatically played.

11. The system of claim 7, wherein the system is implemented as a mobile device.

12. A method for managing a plurality of VOIP conversations over a network, comprising:
enabling a portion of a first VOIP conversation to be communicated over the network; and
enabling a portion of a second VOIP conversation to be communicated over the network, wherein enabling the portion of the second VOIP conversation to be communicated includes pausing the first VOIP conversation, and automatically recording a subsequent portion of the first VOIP conversation.

13. The method of claim 12, further comprising:
selecting to resume the first VOIP conversation comprises pausing the second VOIP conversation, automatically recording of a subsequent portion of the second VOIP conversation and automatically playing the recorded portion of the first VOIP conversation.

14. A client device that is operative to manage a VOIP conversation over a network, comprising:
a processor; and
a memory in communication with the processor use able in storing machine instructions that enables actions, including:
enabling a portion of each of a plurality of VOIP conversations to be communicated over the network, wherein as each VOIP conversation is substantially enabled a currently active VOIP conversation in the plurality of VOIP conversations is paused and recording of a subsequent portion of the paused VOIP conversation is automatically recorded; and
enabling a selection of one of the paused VOIP conversations, wherein another currently active VOIP conversation is paused, recording of another subsequent portion of the paused VOIP conversation is automatically initiated, and the recorded portion of the selected VOIP conversation is automatically played.

15. The client device of claim 14, wherein automatically recording further comprises enabling a party associated with the paused VOIP conversation to provide audio data over the network.

16. The client device of claim 14, the actions further comprising:
terminating a VOIP session associated with one of the plurality of VOIP conversations; and
enabling the associated recorded portion of the VOIP conversation to be accessible for playback over voicemail.

17. The client device of claim 14, the actions further comprising:
terminating a VOIP conversation in the plurality of VOIP conversations; and
providing a response to the terminated VOIP conversation using at least one of a VOIP client, IM client, or voicemail.

18. The client device of claim 14, wherein at least a portion of at least one of the recorded VOIP conversations is stored one at least one of the client device, or a remote server.

19. The client device of claim 14, the actions further comprising:
sending a message indicating a status of a VOIP conversation.

20. A processor readable medium that includes data, wherein the execution of the data provides for the management of VOIP conversations over a network by enabling actions, including:
communicating a portion of a first VOIP conversation over the network;
communicating a portion of a second VOIP conversation over the network, wherein the first VOIP conversation is automatically paused and automatic recording is activated for a subsequent portion of the first VOIP conversation while the first VOIP session is paused; and
resuming the first VOIP conversation, wherein the second VOIP session is automatically paused and automatic recording is activated for a subsequent portion of the second VOIP conversation, and the recorded portion of the first VOIP conversation is played automatically.
